(19) United States
(12) Patent Application Publication
(10) Pub. No.: US 2024/0401716 A1
(43) Pub. Date: Dec. 5, 2024

(54) Valve and Method

(71) Applicant: Dr. Py Institute, LLC, New Milford, CT (US)

(72) Inventor: Daniel Py, New Milford, CT (US)

(21) Appl. No.: 18/732,311

(22) Filed: Jun. 3, 2024

Related U.S. Application Data
(63) Continuation of application No. PCT/US24/32161, filed on Jun. 1, 2024.
(60) Provisional application No. 63/470,356, filed on Jun. 1, 2023.
(60) Provisional application No. 63/470,356, filed on Jun. 1, 2023.

(51) Int. Cl. F16K 31/56

(52) U.S. Cl. CPC F16K 31/56

(57) ABSTRACT

A valve having a valve body defining a flow passageway therethrough, first and second opposing valve chambers located on opposite sides of and intersecting the passageway, first and second valve members respectively movably received within the first and second valve chambers, each valve member defining a stem that engages the other, wherein the stem of the first valve member is movable between first and second positions, and the stem of the first valve member is movable between first and second positions, wherein in the first position of the first valve stem the valve is in an open position permitting passage of substance through the passageway, and in the second position of the first valve stem the valve is in a closed position preventing passage of substance through the passageway.

### CROSS-REFERENCE TO RELATED APPLICATIONS

This patent application claims benefit under 35 U.S.C. § 119 to co-pending U.S. Provisional Patent Application No. 63/470,356, filed Jun. 1, 2023, entitled “Connector Systems,” and claims benefit under 35 U.S.C. § 120 to co-pending International Patent Application No. PCT/US24/32161, filed Jun. 1, 2024, entitled “Valve and Method,” which claims benefit under 35 U.S.C. § 119 to U.S. Provisional Patent Application No. 63/470,356, and contains subject matter contained within U.S. Provisional Patent Application No. 63/352,827, filed Jun. 16, 2022, entitled “Connector Systems,” which are hereby incorporated by reference in their entireties as part of the present disclosure.

### FIELD OF THE INVENTION

The present invention relates to valves and methods of operating valves to control the flow of substances, such as fluids, liquids, gases, gels, creams and flowable solids.

### BACKGROUND

Valves are used to control the flow or transfer of substances, such as the flow of fluids (liquids and gases), as well as semi-fluids, semi-solids, gels, creams and flowable solids, e.g., powders. The transfer of substances in medical or pharmaceutical contexts presents certain challenges. Often, the transfer must be accomplished without contaminating the substance with environmental contaminants, including preventing germ (viruses, bacteria, etc.) ingress into the substance.

It is common in such transfers to use flexible tubing to carry a substance, and connectors to flowingly connect a source of substance to the substance's destination. As an example, it is widely practiced in bioprocessing to cut and weld tubes to withdraw material samples from vessels. Because, prior to welding the ends of the cut tubing and then after sampling cutting the tubing there is a risk of contamination entering into the tubing (and consequently contaminating the material), such connection, and subsequent disconnection, is commonly required to be performed in a controlled and/or classified environment to mitigate the risk of contamination of the substance being transferred and the components (e.g., tubing, connectors, etc.) used to transfer the substance. Current practice includes performing these activities under at least an ISO 5 environment, which implies specialized equipment, sterile gowning for operators and technicians, and training of same, which necessitates significant costs for purchase of equipment and supplies, installation, maintenance and training. As an example, such tasks may need to be performed under an ISO 5 laminar flow hood that is within an ISO 7 “clean room.”

Moreover, prior to disconnection, flow within or from the tubing must be shut-off. Typically, the tube is externally clamped. Nonetheless, clamping may still permit leakage or permit contamination to pass past the clamped portion of the tube. If this occurs, it can result in loss of product and delay to reformulate new/additional product, which can be costly. Further, clamping decreases the volume in the tubing, which can increase the pressure inside the tubing, and can cause ruptures and leaks.

### SUMMARY

It is therefore an object of the present invention that one or more embodiments thereof address, mitigate or overcome one or more of the drawbacks and/or disadvantages of prior transfer systems.

In accordance with one aspect, a valve has a valve body defining a flow passageway therethrough, first and second opposing valve chambers located on opposite sides of and intersecting the passageway, and first and second valve members respectively movably received within the first and second valve chambers. Each valve member defines a stem that engages the other, wherein the stem of the first valve member is movable between first and second positions, and the stem of the first valve member is movable between first and second positions. In the first position of the first valve stem the valve is in an open position permitting passage of substance through the passageway, and in the second position of the first valve stem the valve is in a closed position preventing passage of substance through the passageway.

Each valve member further comprises a biasing member operatively connected to the valve stem thereof. The biasing members are dome shaped. When the valve stem is in the first position thereof, the respective biasing member biases the valve stem in a direction away from the passageway. During movement of the valve stem from the first position thereof toward the second position thereof, the biasing member inverts or invaginates, and, subsequent to said inversion or invagination, the biasing member asserts a force against movement of the valve stem toward the first position thereof.

In further aspects, each valve member includes an actuator that is engageable to move the respective valve stem toward the second position. In additional aspects, each actuator includes indicia indicating or representing an operating condition or configuration of the valve. The indicia can indicate that the valve is open or closed. In certain embodiments, the indicia are colors that are different from each other. In at least some such embodiments, a green color represents the open condition of the valve, and a red color represents the closed condition of the valve.

In yet further aspects, a valve comprises first means defining a first end and a second end, and second means for flowing substance between the first end and the second end. Third means for receiving fourth means therein and sixth means for receiving seventh means thereon are located on an opposite side of the second means from each other and oppose each other. The fourth means defines fifth means, and the seventh means defines eighth means. The third means and the fourth means are configured for relative movement therebetween, wherein the fourth means and the fifth means are movable between a first position and a second position thereof. Movement of fourth means and the fifth means toward the second position is in a direction toward the second means, and movement of the fourth means and the fifth means toward the first position is in a direction away the second means. The sixth means and the seventh means are also configured for relative movement therebetween, wherein the seventh means and the eighth means are movable between a first position and a second position thereof. Movement of the seventh means and the eighth means toward the second position is in a direction toward the second means, and movement of the seventh means and the eighth means toward the first position is in a direction away the second means. Further, movement of the fifth means toward the second positon thereof moves the eighth means toward the first position thereof. Conversely, movement of the eighth means toward the second positon thereof moves the fifth means toward the first position thereof. When the fifth means is in the first position thereof and the eighth means is in the second position thereof, either (i) the fifth means and/or the eighth means define a closed position of the valve and block the second means whereby substance cannot flow between the first end and the second end; or (ii) the fifth means and/or the eighth means define an open position of the valve and do not block the second means whereby substance can flow between the first end and the second end.

The valve also includes ninth means for moving the fifth means toward the second position of the fifth means, and tenth means for moving the eighth means toward the second position of the eighth means. Furthermore, the valve has eleventh means that, when the fifth means is in the first position thereof, biases the fifth means in a direction away from the second means and, during movement of the fifth means from the first position thereof toward the second position thereof, asserts a force against movement of the fifth means toward the first position thereof. Twelfth means bias the eighth means in a direction away from the second means when the eighth means is in the first position thereof. In addition, during movement of the eighth means from the first position thereof toward the second position thereof, the twelfth means assert a force against movement of the eighth means toward the first position thereof.

In some embodiments, the first means is a valve body, the second means is a passageway extending between the first end and the second end, the third means is a first valve chamber, the fourth means is a first valve member, the fifth means is a first valve stem, the sixth means is a second valve chamber, the seventh means is a second valve member, the eighth means is a second valve stem, the ninth means is an engageable actuator operatively connected to the fifth means, the tenth means is an engageable actuator operatively connected to the eight means, the eleventh means is a dome shaped biasing member or spring, and the twelfth means is another done shaped biasing member or spring.

Further embodiments include thirteenth means for indicating or representing one of the open position of the valve or the closed position of valve, and fourteenth means for indicating or representing one of the closed position of the valve or the open position of valve. In some such embodiments, the thirteenth means is an indicia and the fourteenth is comprises another indicia. In certain embodiments, the indicia are colors that are different from each other. In at least some such embodiments, a green color represents the open condition of the valve, and a red color represents the closed condition of the valve.

In another aspect, the valve can be operated according the following process. When the valve stem is in the first position thereof, engaging the associated actuator and moving the first actuator toward the passageway moves the first valve stem toward the second position thereof. During such movement, the associated biasing member inverts or invaginates.

Other objects and advantages of the present invention, and/or of embodiments thereof, will become more readily apparent in view of the following detailed description and accompanying drawings.

### BRIEF DESCRIPTION OF THE DRAWINGS

FIG. 1 schematically depicts a cross-sectional side view of an embodiment of a valve in an open position;

FIG. 2 schematically depicts a cross-sectional side view of the valve of FIG. 1 in a closed position;

FIG. 3 schematically depicts a cross-sectional side view of the valve of FIG. 1 in a disassembled state;

FIG. 4 schematically depicts operating the valve of FIG. 1 from the open position to the closed position;

FIG. 5 schematically depicts operating the valve of FIG. 1 from the closed position to the open position;

FIGS. 6-8 schematically depict use of the valve of FIG. 1 with a fluid connector;

FIG. 9 schematically depicts a cross-sectional side view of another embodiment of a valve in an open position;

FIG. 10 schematically depicts a cross-sectional side view of another embodiment of a valve in an open position;

FIG. 11 schematically depicts a cross-sectional side view of the valve of FIG. 10 in a closed position;

FIG. 12 schematically depicts a top perspective view of the valve of FIG. 10 in the open position;

FIG. 13 schematically depicts a bottom perspective view of the valve of FIG. 10 in the open position;

FIG. 14 schematically depicts a cross-sectional side view of another embodiment of a valve in an open position; and

FIG. 15 schematically depicts a cross-sectional side view of the valve of FIG. 14 in a closed position.

### DETAILED DESCRIPTION

Embodiments are more fully hereinafter with reference to the accompanying drawings. The invention should not be considered or construed to be limited to the embodiments set forth herein.

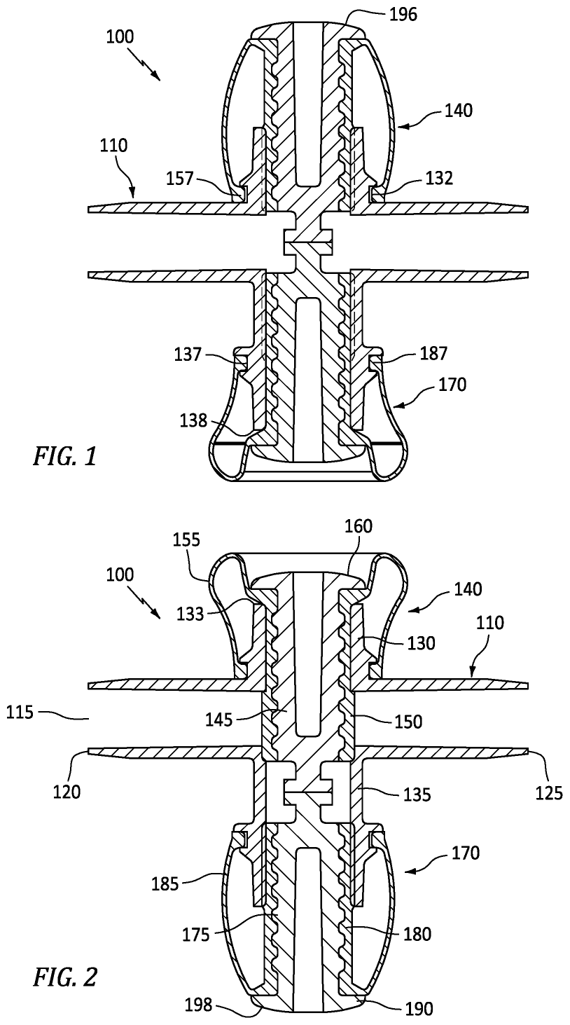

In FIGS. 1-8, illustrate valve is indicated generally by the reference numeral 100. In the illustrated embodiment, the valve 100 comprises a valve body 110, a first valve member 140 and a second valve member 170.

Valve body 110 defines a conduit or passageway 115 through which substance can flow between a conduit first end 120 and a conduit second end 125 when the valve is in the open position. In the illustrated embodiment, the conduit has a generally circular cross-section. However, the invention is not limited to such, and the conduit 115 may have any suitable or desired cross-sectional shape, e.g., oval, square, rectangular, etc. The valve body may be made of any suitable material, as should be understood by those or ordinary skill in the art. However, in some embodiments of the invention, the valve body 110 is comprised of a translucent or transparent material.

The valve body 110 further comprises a first valve slide or valve chamber 130 for receiving the first valve member 140 and a second valve slide or valve chamber 135 for receiving the second the valve member 170. The first and second valve slides 130, 135 intersect the conduit 115 so as to be connected to the conduit 115. The valve slides 130, 135 intersect/connect to the conduit on opposite or opposing sides of the conduit. In the illustrated embodiment, the valve slides 130, 135 have a generally circular cross-section, but may have any suitable or desired cross-sectional shape, e.g., oval, square, rectangular, etc. As further illustrated, the valve slides 130, 135 are oriented/intersect with respect to the conduit 115 at an approximately orthogonal angle. In other embodiments, the valve slides 130, 135 are oriented/intersect with respect to the conduit 115 at a non-orthogonal angle.

The first valve member 140 includes a stem 145, a seal 150, a biasing member 155 and an actuator 160. The stem 145 defines an upper stem portion 145a and a lower stem portion 145b. The second valve member 170 also includes a stem 175, which defines an upper stem portion 175a and a lower stem portion 175b, a seal 180, a biasing member 185 and an actuator 190. As illustrated, for example, in FIGS. 1 and 2, the stem 145 of the first valve member 140 is slidingly received in the first valve slide 130, and the stem 175 of the second valve member 170 is slidingly received in the second valve slide 135.

As illustrated, the seals 150, 180 are attached or adhered to their respective stems 145, 175. The stem 145 and seal 150 are, collectively, configured and dimensioned so that the outer surface 150a of seal 150 and the inner surface 130a of the valve slide 130 define a fluid-tight seal therebetween when the valve member 140 is located within and also moving, e.g., sliding, relative to inner surface 130a of the valve slide 130. Similarly, stem 175 and seal 180 are, collectively, configured and dimensioned so that the outer surface 180a of seal 180 and the inner surface 135a of the valve slide 135 define a fluid-tight seal therebetween when the valve member 170 is located within and also moving, e.g., sliding, relative to inner surface 135a of the valve slide 135. The purpose of these fluid-tight seals is to prevent substances from flowing between the inner surfaces 130a, 135a of the slides 130, 135, e.g., either substances in conduit 115 from leaking or passing out of the valve body 110 or substances from outside the valve body leaking or passing into the conduit 115.

Loss of substance from the conduit 115 into the surrounding environment can be undesirable, implicating not only the economic loss associated with such, but also the adverse effects such loss(es) may have on the system or process in which the valve is located. Furthermore, where a substance within the conduit 115 is a pollutant or toxin, or otherwise dangerous in the surrounding environment, leakage can have adverse if not disastrous consequences to the environment and/or persons and things within the environment. Conversely, the introduction of substances from the external environment into the conduit 115 risks contamination or degradation to substances within the conduit 115 and the conduit 115 itself, as well as other parts of the system or process of which the conduit 115 is a part.

In at least some embodiments, the fluid-tight seals are air/gas-tight or hermetic seals. Such can prevent not only liquids and solids from passing out of the conduit 115 into the ambient environment or into the conduit 115 from the environment, but also air and other gases. Hermetic seals can also reduce or eliminate the passage of microorganisms (viruses, bacteria, etc.) that can contaminate the substances in the conduit 115 and/or the system/process of which the valve body 110 is a part.

Accordingly, as those of ordinary skill in the art should appreciate, the seals 150, 180 can be configured and dimensions and made of material(s) so as to form an adequate fluid-tight seal between the seals 150, 180 and the respective inner surfaces 130a, 135a of the valve slides 130, 135. In the illustrated embodiment, the seals 150, 180 are configured to be approximately the same shape and dimension(s) as the corresponding inner surfaces 130a, 135a. The seals 150, 180 can comprise a flexible and/or compressible material, which can assist in forming the desired seals by allowing the material to conform more closely the inner surfaces 130a, 135a. Exemplary materials can include rubbers and thermoplastic elastomers (TPEs), but as those of ordinary skill in the art should appreciate, any suitable materials can be used, which are known or later become known.

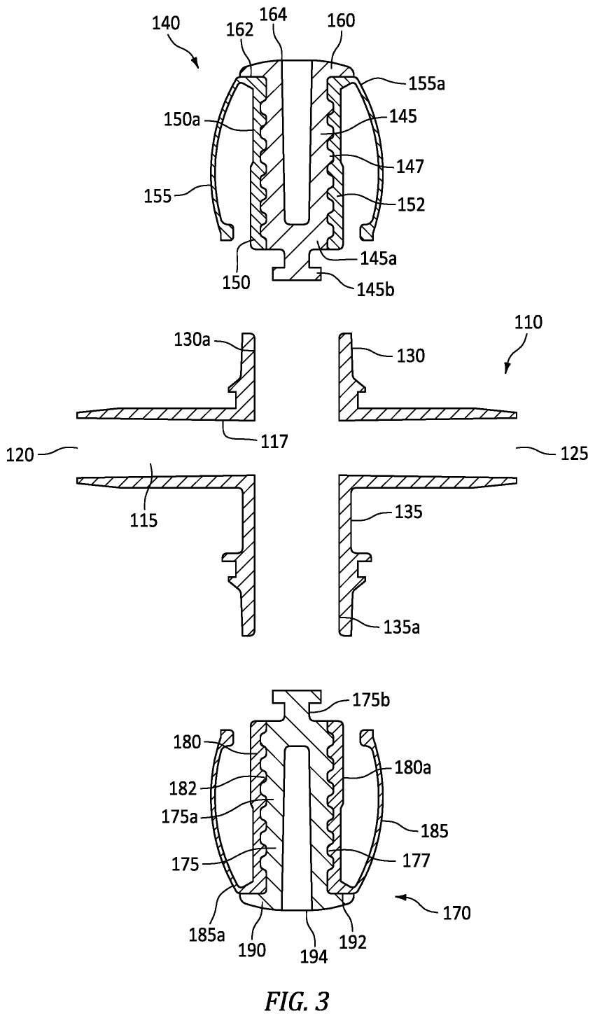

Further, as seen in FIG. 3, the seals 150, 180 are dimensioned to be larger than the corresponding inner surfaces 130a, 135a. When the valve members 140, 170 are located in their respective valve slides 130, 135, the seals 150, 180 are flexed and/or compressed so as to substantially conform to the inner surfaces. This flexion/compression of the seal material acts to increase the contact pressure/force between the seals 150, 180 and the inner surfaces 130a, 135a, increasing the integrity of the seal therebetween.

While in the illustrated embodiments the seals 150, are is located on the respective valve members, other embodiments can have other configurations. For example, a seal or scaling material can be located on the inner surfaces 130a, 135a of the slides 130, 135. The could be, for instance, a material located on the inner surfaces 130a, 135a that engages and forms the seal with the stems 145, 175. As another example, the material of the slides 130, 135 themselves can assist in forming a seal. Use of a flexible and/or elastic material, e.g., rubber or elastic tubing material, can permit the material to more closely conform with the stems 145, 175 to form a seal. Where the inner surfaces 130a, 135a are dimensioned to be smaller than the stems 145, 175, this can cause the inner surfaces 130a, 135a to deform or stretch, increasing the contact pressure/force between the inner surfaces 130a, 135a and the stems 145, 175, increasing the integrity of the seal therebetween.

As those of ordinary skill should appreciate, though, the contact between the seals 150, 180 (or the stems 145, 175) and the inner surfaces 130a, 135a can generate friction therebetween. This can inhibit the relative movement of stems 145, 175 and the respective inner surfaces 130a, 135a during operation of the valve, as further discussed below. Thus, persons of ordinary skill should understand how to configure the valve and materials to use so as to not overly inhibit valve operation. One should understand, for example, that the use of coatings, e.g., PTFE, etc., or lubricants, e.g., graphite, oils, etc., can modify friction without adversely degrading scaling between the stems 145, 175 and the inner surfaces 130a, 135a.

Those in the art should also understand, though, that friction within a valve could have beneficial effect. For example, as those of ordinary skill in the art should appreciate, differentials in pressure-induced forces on the stems 145, 175 from inside the conduit 115 and the outside environment can cause unintended movement of stems 145, 175 relative to the slides 130, 135. On the one hand, above-atmospheric pressures in the conduit 115 could overcome frictional forces and “push” the stems 145, 175 away from the conduit 115. Conversely, where there are sub-atmospheric pressures in the conduit 115, external atmospheric pressure on the stems 145, 175 could overcome frictional forces and “push” the stems 145, 175 toward or into the conduit 115. Accordingly, it is known in valve design to provide an intentional amount of friction to prevent or reduce the risk of unintentional movement/operation of a valve. Doing so, however, results in trade-off with ease of operation of the valve, particularly manually operated valves.

Such trade-off is mitigated, however, by the biasing members 155, 185 of the valve members 140, 170. Generally, the biasing members 155, 185 bias the respective valve members 140, 170 toward and/or away from the conduit 115 by exerting force(s) on the stem 145 or 175 to which they are attach other otherwise act upon. In the illustrated embodiment, biasing member 155 is attached to, and in this case, integral with, the seal 150. In turn, the seal 150 is attached to stem 145, via two means. First, the stem 145 and the seal 150 have mating ridge-and-groove or thread-like structures 147, 152, respectively, that assist in retaining the seal 150 (and thus the attached/integral biasing member 185) to the stem 145 and resist detachment or dislodgement of the seal 150 from the stem 145. Second, the actuator 160 defines a flange or projection 162 that extends beyond the stem 145 and which the seal 150 engages to further assist against dislodgement of the seal 150.

Regarding the valve member 170, the biasing member 185 is attached to and integral with the seal 180, which in turn, is attached to the stem 175 in a similar manner as are similar components of the valve member 140. Similarly to valve member 140, the stem 175 and the seal 180 have mating ridge-and-groove or thread-like structures 177, 182, respectively, and the actuator 190 defines a flange or projection 192 that the seal 180 engages.

The biasing members 155, 185 are configured to exert forces on the respective stem 145, 175 to affect the movement of the respective stem 145, 175. As discussed further below, the biasing members 155, 185 are configured to, depending on the mode of operation, assist or resist movement of the stems 145, 175. The biasing members 155, 185 comprise an elastic material that can compress and extend. During compression and extension, the biasing members 155, 185 exert an opposing force on the stems 145, 175. More specifically, via their attachment/integration with the seals 150, 180, the biasing members 155, 185 exert forces on the respective seals 150, 180, which in turn exert forces on the respective stems 145, 175 via the respective thread like structures 147, 152, 177, 182, and actuator flanges 162, 192. In effect, the biasing members 155, 185 act as or similarly as a spring.

In the present embodiment, the biasing members 155, 185 define or otherwise act similarly to dome springs, as further discussed below. As illustrated, the biasing members 155, 185 define an outwardly curved or convex shape. As discussed above, one end of each biasing members 155, 185 is attached to a respective seal 150, 180. However, those skilled in the art should understand that other configurations could be used. For example, the biasing members 155, 185 can be attached to, engage or be otherwise operatively-connected to the respective stem and/or actuator.

The opposing ends of the biasing members 155, 185 are operatively attached to the valve body 110. In the illustrated embodiment, these ends of the biasing members define inwardly extending projections or rims 157, 187. The valve body 110 defines corresponding recesses or grooves 132, 137 configured to receive the respective projections 157, 187. When the projections 157, 187 are received in or engage the respective recesses 132, 137, the biasing members 155, 185 are secured to the valve body 110 so that they do not detach from the valve body during operation of the valve. In at least some embodiments, the engagement of the projections 157, 187 with the recesses 132, 137 is defined by a snap fit. It should be understood, though, that the biasing members 155, 185 may be attached to the valve body 110 by any suitable means or mechanism, either currently known or later developed, including, but not limited to, adhesives, welding, and clamps. In embodiments where the biasing members 155, 185 comprise a moldable material, such as plastic, TPEs or thermoset elastomers, the biasing members 155, 185 may be over-molded onto the valve body 110. Where the valve body is a moldable material, e.g., plastic, the valve body 110 and the biasing members 155, 185 may be co-molded.

On the other hand, in some embodiments, such as in the illustrated embodiment, where the biasing members 155, 185 comprise an elastic or flexible material (e.g., plastics, metals, rubbers and/or other elastomers, etc.), the biasing members 155, 185 may be disengaged from valve body 110. This can be done by flexing and/or stretching the biasing member so as to disengage the projection from the recess. Such can facilitate removal of the valve members 140, 170 from the valve body 110 (e.g., by sliding the valve members 140, 170 out their respective valve slides 130, 135). This may be desirable to clean, repair or replace the valve members 140, 170 and/or the interior of the valve slides 130, 135 or valve body 110.

While the illustrated embodiment utilizes curved or dome-shaped biasing members, it should be appreciated however, that the biasing members can define other configurations that are known or later become known in which they directly or indirectly bias or otherwise exert forces on the stems 145, 175. By way of example, the biasing members could take the form of a coil or other type of spring, which may be made of metal, plastic, or any of numerous other materials. Also, the shape and/or material of construction of the biasing members may be selected to control the bias or force applied to the valve stems 145, 175.

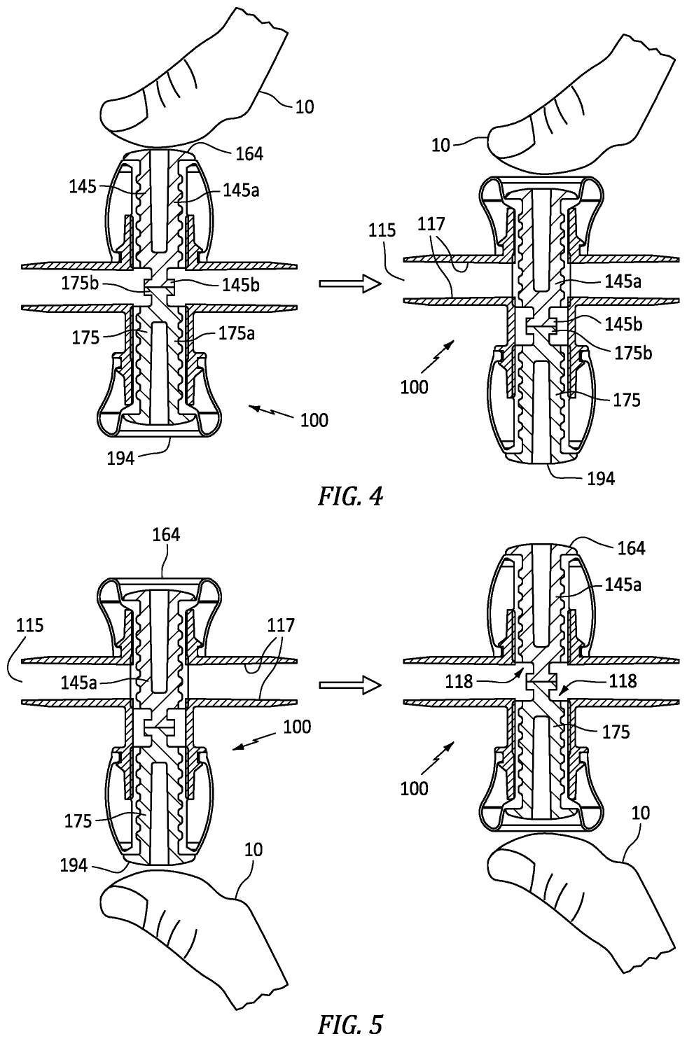

The operation of the valve 100 is illustrated in FIGS. 4 and 5. In FIGS. 1, 4 (left-hand side) and 5 (right-hand side), the valve 100 is shown in an open position. In that position, the lower stem portions 145b, 175b are located within the conduit 115. As seen in the figures, the lower stem portions 145b, 175b are engaged or in contact with each other. The lower stem portions 145b, 175b collectively define dimensions that are smaller than the interior of the conduit 115 at that location. Accordingly, the lower stem portions 145b, 175b do not completely block the conduit 115, and substance can flow through the conduit around the lower stem portions 145b, 175b in the space(s) 118 in between the lower stem portions 145b, 175b and the inner wall 117 of the conduit 15.

In FIGS. 2, 4 (right-hand side) and 5 (left-hand side), the valve 100 is shown in a closed position. In that position, the upper stem portion 145a is located within the conduit 115. The upper stem portion 145a defines dimensions that are at least as large as the conduit 115 at that location and forms a fluid-tight seal with the inner wall 117 of the conduit 115. Accordingly, the upper stem portion 145a completely blocks the conduit 115, and substance cannot flow through the valve.

To operate the valve 100 from the open position to the closed position, a user 10 engages an engageable surface 164 of the actuator 162, and exerts force on the actuator 162 via the engageable surface 164 in a direction toward the conduit 115. When the user exerts sufficient force in that direction, the stem 145 of the first valve member 140 slides or otherwise moves relative to its respective valve slide 130 toward the conduit 115. At the same time, due to the engagement/contact of the lower stem portions 145b, 175b, the movement of the stem 145 toward the conduit 115 causes the stem 175 of the second valve member 170 to move relative to its respective valve slide 135 away from the conduit 115. When the upper stem portion 145a is sufficient displaced so as to transgress across the conduit 115 and block the conduit as shown in FIG. 4 (right-hand side), the valve 100 is in a closed position.

The operation of the valve 100 from the closed positon to the open position is shown in FIG. 5. The user 10 engages an engageable surface 194 of the actuator 192, and exerts force on the actuator 192 via the engageable surface 194 in a direction toward the conduit 115. When the user exerts sufficient force in that direction, the stem 175 of the first valve member 170 slides or otherwise moves relative to its respective valve slide 130 toward the conduit 115. At the same time, due to the engagement/contact of the lower stem portions 145b, 175b, the movement of the stem 175 toward the conduit 115 causes the stem 145 of the first valve member 140 to move relative to its respective valve slide 130 away from the conduit 115. When the upper stem portion 145a is sufficient displaced so as that no longer blocks flow through the conduit 115 and/or the lower stem portions 145b, 175b are located in the conduit 115 as shown in FIG. 5 (right-hand side), the valve 100 is in the open closed position and substance can flow through the valve 100.

In this regard, the each stem 145, 175 comprises a material that is sufficiently strong and/or rigid to be able to move the other stem during operation of the valve. Those of ordinary skill in the art should appreciate that the stems 145, 175 may comprise any material(s) suitable to perform this function, and that such materials may be known or later become known. Exemplary materials may include, but are not limited to, plastics, metals, ceramics, etc., and combinations thereof. Where the material(s) used are suitable, as would be understood by one of ordinary skill in the art, the biasing members 155, 185 may be over-molded to the respective stems 145, 175. In embodiments where the valve stems 145, 175 comprise moldable material(s) (e.g., plastics, thermoplastic materials, thermoset materials, etc., as those of ordinary skill would understand), the biasing members 155, 185 and the respective stems 145, 175 may be co-molded.

The range of motion of the stems 145, 175 during the operation of the valve 100 is limited by the valve slides 130, 135. Each valve slide 130, 135 defines a respective stop surface 133, 138 that limits the movement of the actuator 160 and the actuator 190, respectively, toward the conduit 115, and consequently, limits the movement of the stem 145 and the stem 175, respectively, toward the conduit 115. In the illustrated embodiment the stop surface 133 is located so as to allow the upper stem portion 145a of the first valve member 140 to completely transgress the conduit 115 and thus block the flow of substance through the conduit 115 as seen, for example, in FIG. 2. The stop surface 138 is located so as to prevent the upper stem portion 175a from entering into the conduit 115 as seen, for example, in FIG. 2. Persons of ordinary skill in the art should understand that the illustrated locations of the stop surfaces 133, 138 are exemplary, and the stop surfaces 133, 138 may be located at other locations and provide an operational valve 10. They should also understand that structures other than stop surfaces, which may be currently known or later become known, may be used to limit the motion of the stems.

The biasing members 155, 185 operate during operation of the valve in the following manner. The curved or dome-shaped upper portions 155a, 185a of the biasing members 155, 185 act in a certain manner during a user's actuation of the respective actuator 160, 190, e.g., exertion of force in a direction inwardly toward the conduit 115. Initially, starting from when the biasing member is in an un-deformed condition such as shown FIG. 3, the curve or dome-shape resists inward deformation and exerts an outward force or bias (away from the conduit 115) against the force exerted by the user. As the user continues exert force on the actuator and thus the biasing member, further inwardly deforming the biasing member, the upward counterforce of the biasing member increases and “resists” against the user with increasing deformation.

However, when the upper portion of the biasing member reaches a certain amount of inward deformation, the upper portion inverts or invaginates as can be seen with respect to the biasing member 155 in FIG. 2. Once the biasing member inverts, it no longer exerts an outward force against the actuator. Instead, the inverted upper portion of the biasing member resists outward movement of the actuator and thus the respective stem operatively-connected to the actuator.

Accordingly, in both the open and closed positions of the valve 100, the biasing members 155, 185 act to resist movement of the valve from one position to the other. For example, when the valve 100 is in the open position as seen in FIG. 1, the curved or dome-shaped upper portion 155a of the biasing member 155 resists inward movement of the actuator 160 and the stem 145 to move the stem 145 inwardly and move the stem 175 of the second valve member 170 outwardly to move the valve 100 into the closed position (as seen in FIG. 2). At the same time, the inverted upper portion 185a of the biasing member 185 resists outward movement of the stem 175 and actuator 190 to allow the stem 145 to transgress the conduit 115 and close the valve 100. A similar phenomena occurs when moving the valve 100 from the closed positon to the open positon as depicted in FIG. 5.

The result is that the biasing members impart a resistance to the valve being operated from one position to the other position (from open to closed or from closed to open). Operating the valve thus requires the impart of a certain amount of force on the moving components of the valve, e.g., the actuators, to operate the valve. In other words, the biasing members 155, 185 act to maintain or help maintain the valve 100 in its current position. This helps prevent unintended actuation of the valve, e.g., unintended movement of the valve from the open position to closed position and/or from the closed position to open position.

Those of ordinary skill in the art should appreciate that the amount of resistance that the biasing members impart may be set or controlled by the configuration and material(s) of the biasing members. They should further understand how to set and/or control the amount of resistance via the configuration and/or material(s) of the biasing members, so as to provide a desired resistance and/or a required force to be exerted by a user to operate the valve.

In addition to the functions discussed above, the biasing members 155, 185 may also perform the further functioning of secondary seals to prevent environmental dirt, debris, contaminants, germs, etc. from entering into the valve. In addition, should the seals 145, 175 leak or otherwise fail, the biasing members help prevent substance from the conduit 115 from entering the ambient environment.

In certain embodiments such as in the embodiment of FIGS. 1-8, the actuators 160, 190 further include indicators or indicia 196, 198 that indicate the status of the valve 100, e.g., open or closed. The indicators 196, 198 can be visual in nature, to visually indicate the status. The indicators can be, e.g., colors, with one color located on the actuator 160 and another color located on the actuator 190. For example, one color located on the actuator 160 (e.g., green) can indicate that, when the biasing member 155 is not inverted/invaginated, the valve 100 is open, and another color located on the actuator 190 (e.g., red) can indicate that, when the biasing member 185 is not inverted/invaginated, the valve 100 is closed. Conversely, a color representing the valve being open can be located on the actuator 190 to indicate that, when the biasing member 185 is inverted/invaginated, the valve 100 is open, and a color representing the valve being closed can be located on the actuator 160 to indicate that, when the biasing member 155 is inverted/invaginated, the valve 100 is closed.

Another exemplary visual indicator can be a letter, word or symbol representing that the valve is open, with another letter, word or symbol representing that the valve is closed. For example, the word “open” can represent that the valve is open, and the word “closed” can represent that the valve is closed.

It should be appreciated, however, that any suitable indicia or indicator be used. For example, alternatively or in addition to visual indicators as discussed above, the actuators can include tactile indicators. For example, the actuators can include raised and or recessed surfaces and/or patterns that indicate to a user who touches an actuator the status of the valve.

One attribute of the valve body 110 comprising a translucent or transparent material is that it may permit a user to verify that the position of the valve, e.g., whether it is open or closed. This might be done, for example, by visually noting the positions of the valve stems 145, 175. In the case of confirming the valve is closed, a user may visually verify that the upper stem portion 145a of the first valve member 140 has completely transgressed across the conduit 115 so as to block the passage/flow of substance in the conduit. A user may also, depending on the nature of the substance in the conduit 115 visually verify that the substance has ceased to flow.

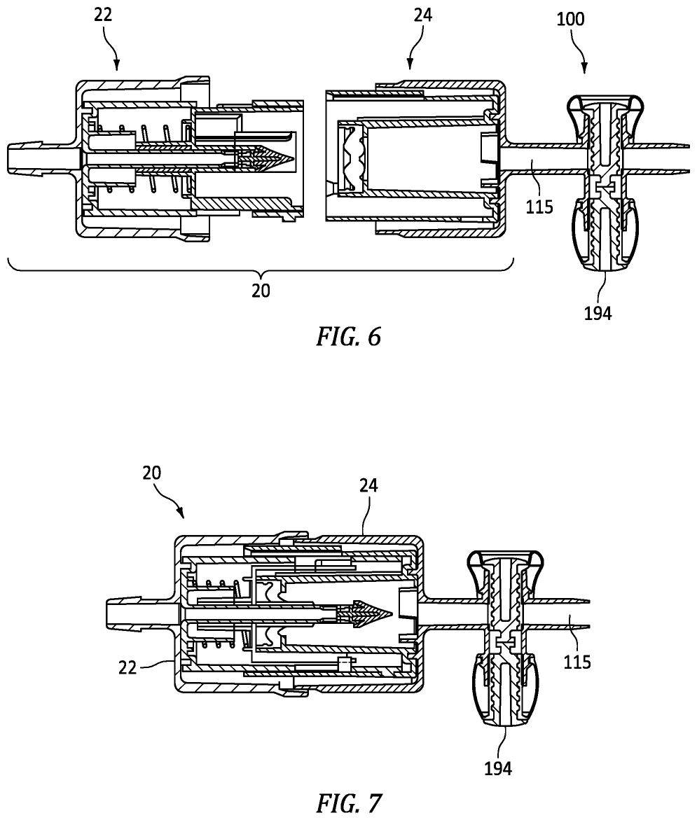

FIGS. 6-8 show an exemplary use and operation of the invention. In the illustrated embodiment, the valve 100 is used with a connector 20. The connector 20 is of a type that is shown and described in U.S. patent application Ser. No. 13/864,919, filed Apr. 17, 2013, entitled “Self-Closing Connector,” which claims the benefit of similarly titled U.S. Provisional Patent Application No. 61/635,258, filed Apr. 18, 2012, and similarly titled U.S. Provisional Patent Application No. 61/625,663, filed Apr. 17, 2012, each of which is hereby expressly incorporated by reference in its entirety as part of the present disclosure as if fully set forth herein. In the illustrated embodiment, the connector 20 is a sterile connector. The connector 20 comprises a “male” connector half 22 and a “female” connector half 24. In the disconnected condition as seen in FIG. 6, substance cannot flow through either the male connector half 22 or the female connector half 24. When the male connector half 22 and the female connector half 24 are engaged together as seen in FIG. 7, substance can flow through and between the two halves.

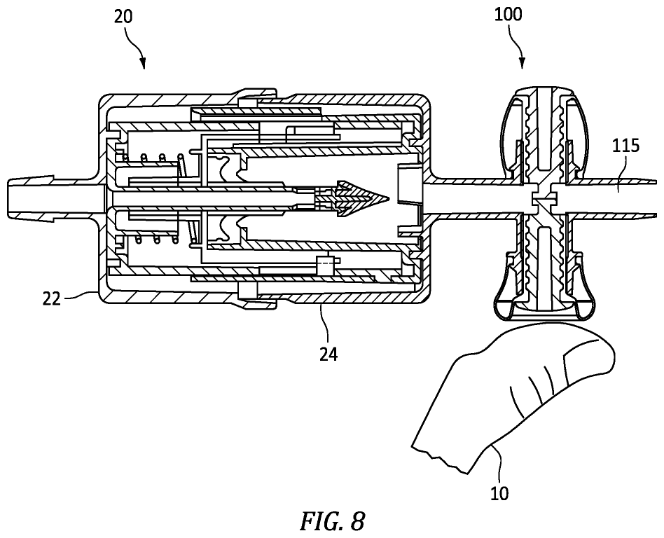

As seen in FIGS. 6-8, the valve 100 is in fluid communication, e.g. connected to, the female connector half 24. Thus, substance can flow between the between the valve 100 and the female connector half 24. However, in the mode shown in FIGS. 6-7, the valve 100 is in the closed position, and substance cannot flow through the valve 100. In order to flow substance through the valve 100, a user 10 can move the valve 100 from the closed position to the open position as shown in FIG. 8, e.g., in the manner described above. Once the valve is placed in the open position, substance can flow through the valve 100, and between the valve 100 and the connector 20. In order to shut off flow through the valve 100, the user may move the valve 100 back to the closed position, in the manner described above. The connector halves 22, 24 may then be disconnected from each other, thereby disconnecting the substance source and the substance destination from each other.

It should be appreciated that, while in FIGS. 6-8 the valve 100 is shown connected to the female connector half 24, the valve 100 could alternatively be connected to the male connector half 22. It should also be appreciated that the invention is not limited to use of the particular connector 20 shown in FIGS. 6-8, and that any suitable sterile or non-sterile connector by may be used. Further exemplary sterile/aseptic connectors are shown and described in U.S. patent application Ser. No. 14/536,566, filed Nov. 7, 2014, entitled “Device for Connecting or Filling and Method;” U.S. patent application Ser. No. 13/874,839, filed Apr. 17, 2013, entitled “Device for Connecting or Filling and Method,” which claims the benefit of similarly titled U.S. Provisional Patent Application No. 61/641,248, filed May 1, 2012, and similarly titled U.S. Provisional Patent Application No. 61/794,255, filed Mar. 15, 2013; U.S. patent application Ser. No. 13/080,537, filed Apr. 5, 2011, entitled “Aseptic Connector with Deflectable Ring of Concern and Method,” which claims the benefit of similarly titled U.S. Provisional Application No. 61/320,857, filed Apr. 5, 2010; U.S. patent application Ser. No. 15/410,762, filed Jan. 19, 2017, entitled “Single Use Connectors;” U.S. patent application Ser. No. 16/132,354, filed Sep. 14, 2018, entitled “Connector Assembly, Connectors Therefor, and Method;” and co-pending U.S. Provisional Patent Application No. 63/470,356, filed Jun. 1, 2023, entitled “Connector Systems,” to which the present application claims benefit under 35 U.S.C. § 119, each and all of which are hereby expressly incorporated by reference in its entirety as part of the present disclosure as if fully set forth herein.

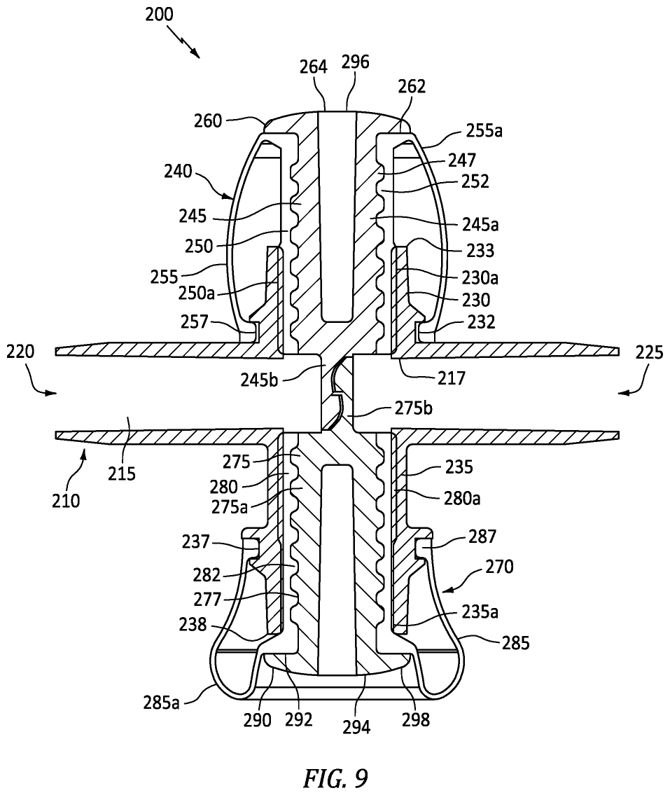

Turning to FIG. 9, another embodiment of a valve is indicated generally by the reference numeral 200. The valve 200 is substantially similar to the valve 100 described above, and therefore like reference numerals preceded by the numeral “2” instead of the numeral “1,” are used to indicate like elements. One difference between valve 200 and valve 100 is the configuration of the valves' stems. More specifically, the configurations of the lower stem portions 245b and 275b of valve 200 differ from the lower stem portions 145b and 175b of valve 100. In valve 200, the lower stem portions 245b, 275b each define a recess 245c, 275c and a projection 245d, 275d configured to engage a respective projection 245d, 275d and recess 245c, 275c, so as to connect the lower stem portions 245b, 275b together. Such configurations can assist in maintaining alignment of the stems 245, 275.

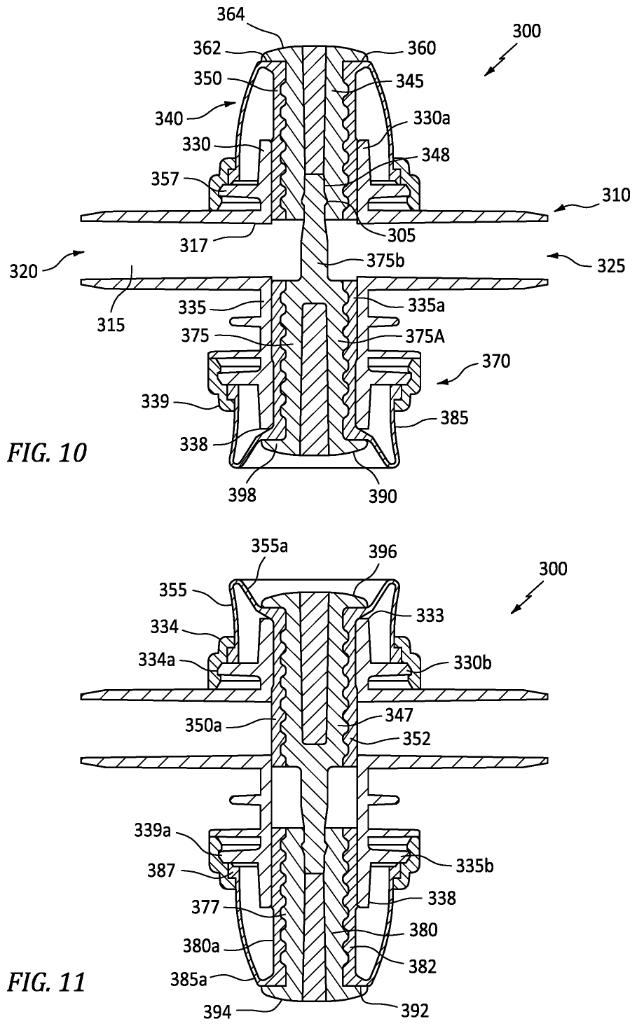

In FIGS. 10-13, another embodiment of a valve is indicated generally by the reference numeral 300. The valve 300 is similar to valve 100 and valve 200 described above, and therefore like reference numerals preceded by the numeral “3” instead of the numeral “1” or “2” are used to indicate like elements. One difference between valve 300 and valves 100 and 200 is that the stems 345, 375 have different lengths than the stems in valves 100 and 200. In the illustrated embodiment, the stem 375 is longer than the stem 345 such that the stem 375 extends into a recess 348 in stem 345. Such configurations can assist in maintaining alignment of the stems 345, 375. As also illustrated, stem 375 and the recess 348 define a detent that assists in maintaining a connection between the stems 345, 375. It should be understood, though, that, alternatively, the stem 345 can be longer than the stem 375 such that stem 345 extends into a recess of the stem 375 and, optionally, the stems 345, 375 define a detent 305.

Another difference is the manner in which the biasing members 355, 385 are secured the valve body 310. As illustrated, the valve slides 330, 335 each define a respective projection or flange 330b, 335b. The projections/rims 357, 387 of the biasing members 355, 385, which in the illustrated embodiment extend in an outward direction, are seated against the respective flange 330b, 335b. Caps 334, 339 engage both a respective flange 330b, 335b and a respective projection 357, 387 to secure the projections 357, 387, and thus the respective biasing members 355, 385, to the respective flange 330b, 335b and thus the valve body 310. In the illustrated embodiment, the caps 334, 339 and the respective flange 330b, 335b define a detent 334a, 339a. However, those of ordinary skill in the art should appreciate that other means and mechanisms to connect the caps 334, 339 to the valve body 310 that are currently known or later developed may be used. Non-limiting examples include a snap fit, a threaded connection in which the cap and the valve body define corresponding matting threads, adhesives and/or welding.

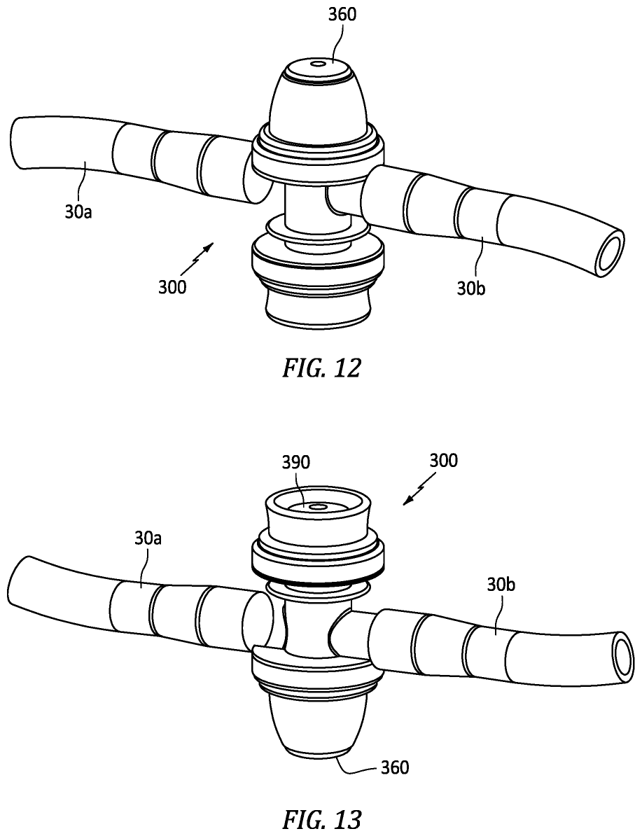

FIGS. 12-13 illustrate an exemplary use of valve 300. In those figures, the valve 300 is connected to tubing portions 30a, 30b. FIGS. 12 and 13 show the valve 300 in the open position. Thus, in the mode shown in FIGS. 12 and 13, substance can flow between tubing portions 30a and 30b through the valve 300.

While, as described above, the biasing members assist in maintaining the valve in the open or closed position, the valve may have additional or alternative means or mechanisms for doing so. For example, as discussed above, friction between a valve stem or seal and its respective valve slide resists movement of the valve stems. In some embodiments, the materials and configurations of the seals and/or valve slides define an amount or degree of friction that permits intentional movement of the valve stems, but prevents unintentional movement. Those of ordinary skill in the art should understand how to achieve this. As another example, the valve may include a detent or similar mechanism that is engaged when the valve is in the open and/or closed position, configured to increase the force needed to move the valve stems out of the open and/or closed position, to prevent or reduce unintentional movement thereof. Again, those of ordinary skill in the art should understand how to design and make such mechanisms. They should also appreciate that the above-discussed examples are non-limiting, and that other, currently know or later known mechanisms can be used.

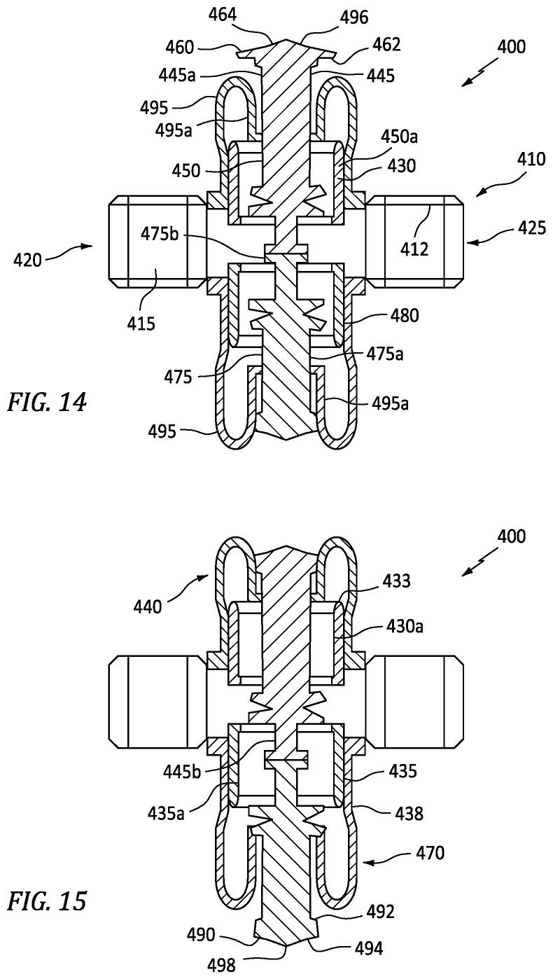

In FIGS. 14 and 15, another embodiment of a valve is indicated generally by the reference numeral 400. The valve 400 is similar to valve 100, valve 200 and valve 300 described above, and therefore like reference numerals preceded by the numeral “4” instead of the numeral “1,” numeral “2” or “3” are used to indicate like elements. Unlike valves 100, 200 and 300, the valve 400 does not include biasing members. Instead, friction between the seals 450, 480 and the inner surfaces 430a, 435a of the valve slides 430, 435 maintain the valve 400 in the open and closed positions during operation. Nonetheless, the stems 445, 475, seals 450, 480 and inner surfaces 430a, 435a are configured to provide an amount of friction that still allows a user to operate the valve between its open position (as seen in FIG. 14) and its closed position (as seen in FIG. 15) when desired.

In addition, valve 400 includes secondary seals 495. These secondary seals 495 perform the same or similar secondary sealing function as do the biasing members discussed above. The secondary seals 495 each have an inverted or invaginated portion 495a that sealingly engage the stems 445, 475. The inverted/invaginated configuration performs multiple functions. For example, the inverted configuration of the inverted portion 495a increases the strength and rigidity of the secondary seal at the area in which it engages the stem. This reduces or eliminates distortion of the secondary seal during relative movement of the stem and the secondary seal due to friction therebetween, particularly during movement of the stem away from the conduit 415, which can impair the integrity of the seal between the inverted portion 495a and the stem.

Yet further, in embodiments in which the inverted portion 495a comprises an elastic material, the inverted material will exert a radially-inward force against the stem. Such can assist in forming and maintaining a seal between the inverted portion 495a and the stem.

As may be recognized by those of ordinary skill in the pertinent art based on the teachings herein, numerous changes and modifications may be made to the above-described and other embodiments without departing from its scope as defined in the claims. For example, the components of the valve may take any of numerous different configurations, or may be made of any of numerous different materials, that are currently known, or that later become known. In addition, though embodiments herein are described and/or shown as used with certain connectors, the invention may be utilized with any components through, from or to which substance flows. Yet further, though the invention is described and discussed herein with respect to certain applications, the invention is not limited to such or any particular applications. Rather, the invention applies to and may be used with any application that may include a valve. Accordingly, this detailed description of embodiments is to be taken in an illustrative, as opposed to a limiting sense.

What is claimed is:

1. An valve comprising:
a valve body defining a first end and a second end, and a passageway extending between the first end and the second end configured for substance to flow between the first end and the second end, the valve body further defining a first valve chamber adapted to receive therein a first valve member and intersecting with the passageway, and a second valve chamber located on an opposite side of the passageway relative to the first valve chamber and opposing the first valve chamber, wherein the second valve chamber is adapted to receive therein a second valve member and intersect with the passageway;
a first valve member received within the first valve chamber and defining a first valve stem, wherein the first valve member and the first valve chamber are configured for relative movement therebetween, whereby the first valve member and the first valve stem are movable between a first position and a second position thereof, wherein movement of the first valve member and the first valve stem toward the second position is in a direction toward the passageway, and movement of the first valve member and the first valve stem toward the first position is in a direction away the passageway;
a second valve member received within the second valve chamber and defining a second valve stem, wherein the second valve member and the second valve chamber are configured for relative movement therebetween, whereby the second valve member and the second valve stem are movable between a first position and a second position thereof, wherein movement of the second valve member and the second valve stem toward the second position is in a direction toward the passageway, and movement of the second valve member and the second valve stem toward the first position is in a direction away the passageway;
a first actuator operatively connected to the first valve stem and engageable to move the first valve stem toward the second position of the first valve stem; and
a second actuator operatively connected to the second valve stem and engageable to move the second valve stem toward the second position of the second valve stem;
wherein the first valve stem and the second valve stem are in contact or engaged with each other;
wherein movement of the first valve stem toward the second positon thereof moves the second valve stem toward the first position thereof;
wherein movement of the second valve stem toward the second positon thereof moves the first valve stem toward the first position thereof; and
wherein when the first valve stem is in the first position thereof and the second valve stem is in the second position thereof, either (i) the first valve stem and/or the second valve stem define a closed position of the valve and block the passageway whereby substance cannot flow between the first end and the second end; or (ii) the first valve stem and/or the second valve stem define an open position of the valve and do not block the passageway whereby substance can flow between the first end and the second end;
the first valve member further comprises a first biasing member operatively connected to the first valve stem, wherein the first biasing member is dome shaped and, when the first valve stem is in the first position thereof, the first biasing member biases the first valve stem in a direction away from the passageway, and during movement of the first valve stem from the first position thereof toward the second position thereof, the first biasing member inverts or invaginates, and, subsequent to said inversion or invagination, the first biasing member asserts a force against movement of the first valve stem toward the first position thereof; and
the second valve member further comprises a second biasing member operatively connected to the second valve stem, wherein the second biasing member is dome shaped and, when the second valve stem is in the first position thereof, the second biasing member biases the second valve stem in a direction away from the passageway, and during movement of the second valve stem from the first position thereof toward the second position thereof, the second biasing member inverts or invaginates, and, subsequent to said inversion or invagination, the second biasing member asserts a force against movement of the second valve stem toward the first position thereof.

2. A valve as defined in claim 1, wherein first actuator includes a first indicia indicating or representing one of the open position of the valve or the closed position of valve, and the second actuator includes a second indicia indicating or representing the other of the closed position or the open positon of the valve.

3. A valve as defined in claim 2, wherein the first indicia and the second indicia comprise a visual indication or representation.

4. A valve as defined in claim 2, wherein the first indicia defines a first color and the second indicia defines a second color.

5. A valve as defined in claim 2, wherein the first indicia defines a green color and the second indicia defines a red color.

6. A valve as defined in claim 2, wherein the open position is indicated or represented by a green color, and the closed position is indicated or represented by a red color.

7. A valve as defined in claim 1, wherein the first valve member is slidingly movable relative to the first valve chamber, and the second valve member is slidingly movable relative to the second valve chamber.

8. An valve comprising:
first means defining a first end and a second end;
second means for flowing substance between the first end and the second end;
third means for receiving therein fourth means and for intersecting with the second means, wherein the fourth means defines fifth means;
sixth means located on an opposite side of the second means relative to and opposing the third means for intersecting with the second means and for receiving therein seventh means, wherein the seventh means defines eighth means;
wherein the third means and the fourth means are configured for relative movement therebetween, whereby the fourth means and the fifth means are movable between a first position and a second position thereof, wherein movement of the fourth means and the fifth means toward the second position is in a direction toward the second means, and movement of the fourth means and the fifth means toward the first position is in a direction away the second means;
wherein the sixth means and the seventh means are configured for relative movement therebetween, whereby the seventh means and the eighth means are movable between a first position and a second position thereof, wherein movement of the seventh means and the eighth means toward the second position is in a direction toward the second means, and movement of the seventh means and the eighth means toward the first position is in a direction away the second means;
wherein movement of the fifth means toward the second positon thereof moves the eighth means toward the first position thereof;
wherein movement of the eighth means toward the second positon thereof moves the fifth means toward the first position thereof; and
wherein when the fifth means is in the first position thereof and the eighth means is in the second position thereof, either (i) the fifth means and/or the eighth means define a closed position of the valve and block the second means whereby substance cannot flow between the first end and the second end; or (ii) the fifth means and/or the eighth means define an open position of the valve and do not block the second means whereby substance can flow between the first end and the second end;
the valve further comprising
ninth means for moving the fifth means toward the second position of the fifth means;
tenth means for moving the eighth means toward the second position of the eighth means;
eleventh means for, when the fifth means is in the first position thereof, biasing the fifth means in a direction away from the second means, and for, during movement of the fifth means from the first position thereof toward the second position thereof, asserting a force against movement of the fifth means toward the first position thereof; and
twelfth means for, when the eighth means is in the first position thereof, biasing the eighth means in a direction away from the second means, and for, during movement of the eighth means from the first position thereof toward the second position thereof, asserting a force against movement of the eighth means toward the first position thereof.

9. The valve as defined in claim 8, wherein the first means is a valve body, the second means is a conduit of passageway extending between the first end and the second end, the third means is a first valve chamber, the fourth means is a first valve member, the fifth means is a first valve stem, the sixth means is a second valve chamber, the seventh means is a second valve member, the eighth means is a second valve stem, the ninth means is an engageable actuator operatively connected to the fifth means, the tenth means is an engageable actuator operatively connected to the eighth means, the eleventh means is a dome shaped biasing member or spring, and the twelfth means is another dome shaped biasing member or spring.

10. The valve as defined in claim 8, further comprising thirteenth means for indicating or representing one of the open position of the valve or the closed position of valve, and fourteenth means for indicating or representing one of the closed position of the valve or the open position of valve.

11. The valve as defined in claim 10, wherein the thirteenth means comprises an indicia and the fourteenth means comprises another indicia.

12. A method of operating a valve of claim 1, the method comprising:
(a) when the first valve stem is in the first position thereof
(1) engaging the first actuator and moving the first actuator toward the passageway, thereby moving the first valve stem toward the second position thereof; and
(2) during the step of moving the first valve stem toward the second position thereof, inverting or invaginating the first biasing member; and
(b) when the second valve stem is in the first position thereof
(1) engaging the second actuator and moving the second actuator toward the passageway, thereby moving the second valve stem toward the second position thereof; and
(2) during the step of moving the second valve stem toward the second position thereof, inverting or invaginating the second biasing member.

13. A method according to claim 12, wherein
when the first valve stem is in the first position thereof, the valve defines the open position, and when the second valve stem is in the first position thereof, the valve defines the closed position;
performing step (a) reconfigures the valve from the open position to the closed position; and
performing step (b) reconfigures the valve from the closed position to the open position.

14. A method according to claim 12, wherein
when the first valve stem is in the first position thereof, the valve defines the closed position, and when the second valve stem is in the first position thereof, the valve defines the open position;
performing step (a) reconfigures the valve from the closed position to the open position; and
performing step (b) reconfigures the valve from the open position to the closed position.
